(19) United States
(12) Patent Application Publication
(10) Pub. No.: US 2021/0355634 A1
(43) Pub. Date: Nov. 18, 2021

(54) A COMPOSITION FOR USE AS PEROXIDE STABILIZER

(71) Applicant: KEMIRA OYJ, Helsinki (FI)

(72) Inventors: Zhijiao LI, Shanghai (CN); Rui LIU, Shanghai (CN)

(21) Appl. No.: 17/287,655

(22) PCT Filed: Nov. 7, 2018
(86) PCT No.: PCT/CN2018/114403

§ 371 Date: Apr. 22, 2021

(51) Int. Cl. D21C 9/10; D21C 9/16

(52) U.S. Cl. CPC D21C 9/1036; D21C 9/163

(57) ABSTRACT

“A composition for use as peroxide stabilizer in bleaching of pulp is provided. The composition comprises iminodisuccinic acid (IDS) or its salt(s), and sodium salt of polyaspartic acid (PASP).”

### FIELD OF THE INVENTION

The present invention relates to a composition for use as peroxide stabilizer in bleaching of pulp and a method for bleaching pulp according to the independent claims presented below.

### BACKGROUND OF THE INVENTION

Hydrogen peroxide is commonly used as a bleaching chemical in pulp bleaching processes. Hydrogen peroxide will however decompose into hydroxyl radicals at the high temperature and high alkali conditions appeared on pulp production. Hydrogen peroxide is also catalytically decomposed in the presence of metal ions such as iron, manganese and copper. The hydroxyl radicals formed in the decomposition of hydrogen peroxide, will deteriorate the fibers and darken the fibers. In addition, because of the decomposition, hydrogen peroxide must be dosed in higher amounts to the bleaching process causing increasing costs.

To improve the efficiency of hydrogen peroxide, stabilizing agents are commonly added during preparation of the peroxide bleach. Sodium silicate (waterglass) is commonly used to stabilize hydrogen peroxide in bleaching mechanical pulps to high brightness, since it is relatively cost-effective. Although silicate is efficient stabilizer and beneficial in peroxide bleaching, it may generate serious detrimental effects in the pulp and paper making processes. Silicate may cause deposits on the paper machine and it also introduces anionicity into papermaking system, leading to higher wet-end chemicals consumption. Therefore, there is a constant demand for cost-effective silicate-free peroxide stabilizer to solve aforementioned problems.

Also, phosphorus chelators, such as diethylenetriamine penta(methylene phosphonic acid) (DTPMP) and hydroxyethylidene diphosphonic acid (HEDP) are commonly used as peroxide stabilizer in bleaching of mechanical pulp due to low price. However, phosphorous chelators may cause severe scaling not only in pulping line but also in evaporator, and the scaling further causes reduced pulping production and even shutdowns for cleaning. Phosphorous chelator may also be hazardous to environment.

There is a constant demand for cost-effective peroxide stabilizers especially in bleaching of high yield pulps. A high yield pulp has low production costs and it would be advantageous if the bleaching can also be carried out by cost-effective way.

### SUMMARY OF THE INVENTION

It is an object of the present invention to reduce or even eliminate the above-mentioned problems appearing in prior art.

The object of the invention is to provide a novel cost-effective hydrogen peroxide stabilizer in pulp bleaching process, especially suitable for use in high yield pulp bleaching process.

It is especially an object of the present invention to provide a biodegradable phosphorus-free peroxide stabilizer in pulp bleaching process.

Further, it is an object to provide a peroxide stabilizer composition, which provides a synergistic effect by improving or at least maintaining stability of the peroxide in bleaching process and providing high brightness to high yield pulp. To make it possible to replace low yield bleached chemical pulps in various products it is essential to reach higher brightness and reduce chemical costs in high yield pulp bleaching.

In order to achieve among others the objects presented above, the invention is characterized by what is presented in the characterizing parts of the enclosed independent claims.

Some preferred embodiments of the invention will be described in the other claims.

The embodiments and advantages mentioned in this text relate, where applicable, both to the composition, the method as well as to the uses according to the invention, even though it is not always specifically mentioned.

A typical composition according to the present invention for use as peroxide stabilizer in bleaching of pulp comprises
iminodisuccinic acid (IDS) or its salt(s), and
sodium salt of polyaspartic acid (PASP),

wherein the ratio of iminodisuccinic acid (IDS) or its salt(s) to sodium salt of polyaspartic acid (PASP) is from 1:20 to 20:1 by weight, preferably from 1:10 to 10:1 by weight, and more preferably from 1:1 to 3:1 by weight.

Typical method according to the invention comprises adding a composition according to the present invention to pulp, preferably to high yield pulp prior to bleaching and/or during bleaching process. A high yield pulp (HYP) refers to a pulp produced at a yield over 85% from raw materials by means of mechanical or combined chemical and mechanical unit processes.

It has been found that a mixture of iminodisuccinic acid (IDS) or its salt(s), and sodium salt of polyaspartic acid (PASP) provides a good stabilizing effect for hydrogen peroxide in pulp bleaching process and also provides better brightness. A composition according to the invention can also chelate heavy metal ions to prevent decomposition of hydrogen peroxide.

The peroxide stabilizer composition according to the preferred embodiment of the present invention is phosphorus-free and biodegradable which is beneficial for environment. The composition according to the present invention can also inhibit common scales in pulping process and also reduce scaling caused by shutdown and so cleaning cost and dust problems can be reduced.

A composition according to the present invention comprises iminodisuccinic acid (IDS) or its salt(s) and sodium salt of polyaspartic acid (PASP) in a ratio from 1:20 to 20:1 by weight, preferably from 1:10 to 10:1 by weight, and more preferably from 1:1 to 3:1 by weight. In a preferred embodiment according to the invention the composition comprises iminodisuccinic acid (IDS) or its salt(s) and sodium salt of polyaspartic acid (PASP) in a ratio of 2:1 by weight.

In an embodiment according to the present invention, a composition comprises water-soluble salt of iminodisuccinic acid, such as tetrasodiumiminodisuccinate, which is a sodium salt of iminodisuccinic acid.

Sodium salt of polyaspartic acid (PASP) is a biodegradable, water soluble polymer based on the amino acid aspartic acid. According to an embodiment of the invention a molecular weight of sodium salt of polyaspartic acid is in the range of 2000-8000 Da, more preferably in the range of 3000-5000 Da.

The composition according to the present invention is alkaline liquid product, which makes possible to add said composition directly into a pulping and bleaching process, and/or mixed with other pulping chemicals. The alkaline composition according to the present invention can be added into anywhere of pulping process, such as pretreating of pulp, bleaching of pulp, storage tower(s), or mixed with other chemicals. In a typical embodiment according to the invention, pH of said composition is in the range of 9-12, preferably pH is >10.

A composition according to the present invention is preferably pre-mixed. A viscosity of the pre-mixed composition according to the invention comprising iminodisuccinic acid (IDS) or its salt(s) and sodium salt of polyaspartic acid (PASP) is typically about 10-40 mPas.

A composition according to the present invention may further comprise chelant, dispersant, penetrant, activator or any combination of them. A chelant may comprise e.g. ethylenediaminetetraacetic acid (EDTA), diethylenetriaminepentaacetic acid (DTPA), ethylenediamine-N,N′-disuccinic acid (EDDS), aspartic acid ethoxysuccinate (AES), diethylenetriamine penta(methylene phosphonic acid) (DTPMP) and/or hydroxyethylidene diphosphonic acid (HEDP). A dispersant may comprise e.g. polyacrylic acid (PAA) and/or polyacrylic acid sodium salt (PAAS). A penetrant may comprise e.g. fatty alcohol polyoxyethylene ethers AEO, OEP, AEP, JFC, and/or APG. An activator may comprise e.g. sodium nonanoyloxybenzenesulfonate (NOBS), tetraacetylethylenediamine (TAED) and/or polyalkylene glycols PAG.

A composition according to the present invention is used as peroxide stabilizer in bleaching of pulp. In a preferred embodiment according to the invention, a composition is used as peroxide stabilizer in bleaching of high yield pulp for providing a cost-effective bleaching process and chemical costs of the high yield pulp may be kept low with high brightness of the pulp. A high yield pulp may comprise high yield mechanical pulp, high yield chemi-mechanical pulp, high yield semi-chemical pulp or any combination of them. A high yield mechanical pulp may be manufactured by various mechanical pulping methods, such as e.g. thermo groundwood (TGW) pulping, stone groundwood (SGW) pulping, pressurized groundwood (PGW) pulping, refiner mechanical (RMP) pulping, pressure refiner mechanical (PRMP), thermomechanical pulping (TMP), extruder mechanical pulping (EMP) and/or biomechanical pulping (Bio-MP). A chemi-mechanical pulp may be e.g. chemi-thermomechanical pulp (CTMP), thermomechanical chemical pulp (TMCP), thermo-chemi-mechanical pulp (TCMP), bleached chemi-thermomechanical pulp (BCTMP), chemimechanical pulp (CMP), alkaline peroxide mechanical pulp (APMP) and/or preconditioning refiner chemic alkaline peroxide mechanical pulp (PRC-APMP). A high yield pulp may comprise a semi-chemical pulp (SCP), neutral sulfite semi-chemical pulp (NSSC) and/or alkaline sulfite semi-chemical pulp (ASSC).

According to an embodiment of the present invention, a composition is added in an amount of 0.1-5 kg/t pulp (dry) or 0.5-5 kg/t pulp (dry) for achieving desired stabilizing effects.

EXPERIMENTAL PART

A better understanding of the present invention may be obtained through the following examples which are set worth to illustrate but are not to be construed as the limit of the present invention.

Stability Test

The physical properties and stability of IDS, PASP and mixture of IDS and PASP (2:1 as the quality ratio) were detected.

pH was measured without dilution by Mettler Toledo SN657 pH meter. Viscosity was measured by Brookfield viscometer, (#61 spindle, 60 rpm). Density was tested by Mettler Toledo DA-100M density meter in 20° C.

Test method of solid content: The samples were weighed about 10 g on the weighed aluminium plates. The samples were dried in 120° C. for 4 hours, and then cooling down the samples in exicator for 20 min. The dry samples were weighed on the aluminium plates.

TABLE 1
Test results of pH, viscosity, solid content and density.

| | Viscosity | | Density | Solid |
|---|---|---|---|---|
| | mPas | pH | g/cm³ | content |
| IDS | 27.1 | 10.70 | 1.316 | 44.6% |
| PASP | 76.7 | 9.88 | 1.283 | 46.5% |
| Mixture | 31.2 | 10.71 | 1.306 | 43.1% |
| (IDS:PASP = 2:1) | | | | |

The stability of the samples was studied at 5° C., 20° C. and 45° C. for one month.

TABLE 2
Stability test results.

| | | |
|---|---|---|
| 5° C. | 20° C. | 45° C. |

| | |
|---|---|
| PASP | The liquid is homogeneous and has no variation |
| IDS | The liquid is clear and colorless like water |
| Mixture | The liquid is homogeneous and stable |
| (IDS:PASP = 2:1) | |

All three samples are stable and homogenous at 5° C., 20° C. and 45° C. for one month. Molecular weight of PASP (CAS No. 181828-06-8, 35608-40-6) used in the test was around 4800 analyzed with GPC instrument. IDS used in the tests was tetrasodiumiminodisuccinate.

Application Example: Peroxide Stabilizer Evaluation Using Mixing Soda

Test Procedure:

1. 30 g O.D. of bleached chemi-thermomechanical pulp (BCTMP) sample was weighed, consistency of the pulp was 35%.

2. A stabilizer used in test was diluted into 10%. Mixing soda and diethylenetriaminepentaacetic acid (DTPA) were mixed together.

3. A pulp sample was heated at the micro-wave oven for one minute, and then a stabilizer, pre-mixed mixing Soda and DTPA, peroxide and balance water are added to the pulp sample. Then the pulp sample was put into water bath at the bleaching conditions.

4. After bleaching, 5 g O.D. pulp was taken and diluted into 1000 mL using DI water, and pH was adjusted into 4.7-5.2. The handsheets using Buchner funnel was taken and pressed and then they were air dried for 24 hours, pressed again, and after brightness was analysed.

5. 10 g or 15 g O.D. of pulp sample was taken and diluted into 10% using DI water dilute. From filtrate, pH and residual peroxide were measured.

Stabilizers used in the tests are described in Table 3. PASP and IDS was same as used in the stability test. The results are presented in Table 4. Test 1 was reference measurement.

As a summary of the application example, a mixture of IDS and PASP according to the present invention provides better brightness gain as IDS or PASP alone. In comparison to commercial Fennobrite C5022 (Kemira Oyj) stabilizer, the composition according to the present invention provides similar brightness gain. A mixture of IDS and PASP according to the present invention provides effective bleaching due to lower residual peroxide.

TABLE 3

| | | | Mixing | | | | | | |
|---|---|---|---|---|---|---|---|---|---|
| | Stabilizer | | soda | Chelant | | Peroxide | Bleaching | Bleaching | Bleaching |
| | dosage | | dosage | dosage | | dosage | consistency | temperature | time |
| TEST | kg/t | | kg/t | kg/t | | kg/t | % | ° C. | min |
| 1 | — | — | — | — | — | — | — | — | — |
| 2 | Fennobrite | 1.5 | 19.0 | DTPA | 4.0 | 51.0 | 20% | 95 | 50 |
| | C5022 | | | | | | | | |
| | (Kemira | | | | | | | | |
| | Oyj) | | | | | | | | |
| 3 | IDS | 2.3 | 19.0 | DTPA | 4.0 | 51.0 | 20% | 95 | 50 |
| 4 | mixture of | 2.3 | 19.0 | DTPA | 4.0 | 51.0 | 20% | 95 | 50 |
| | IDS and | | | | | | | | |
| | PASP 1:1 | | | | | | | | |
| 5 | mixture of | 2.3 | 19.0 | DTPA | 4.0 | 51.0 | 20% | 95 | 50 |
| | IDS and | | | | | | | | |
| | PASP 2:1 | | | | | | | | |
| 6 | mixture of | 2.3 | 19.0 | DTPA | 4.0 | 51.0 | 20% | 95 | 50 |
| | IDS and | | | | | | | | |
| | PASP 3:1 | | | | | | | | |
| 7 | PASP | 2.3 | 19.0 | DTPA | 4.0 | 51.0 | 20% | 95 | 50 |

TABLE 4
Results.

| | | | Average | | Residual | Brightness |
|---|---|---|---|---|---|---|
| | Brightness | | brightness | Filtrate | H2O2 | gain |
| TEST | % ISO | | % ISO | PH | kg/BDMT | % ISO |
| 1 | 53.19 | 53.19 | 53.19 | — | — | 0.00 |
| 2 | 75.14 | 75.06 | 75.10 | 8.66 | 5.52 | 21.95 |
| 3 | 74.02 | 74.18 | 74.10 | 8.74 | 4.45 | 20.83 |
| 4 | 74.79 | 74.62 | 74.71 | 8.73 | 4.85 | 21.60 |
| 5 | 75.79 | 75.91 | 75.85 | 8.75 | 3.53 | 22.60 |
| 6 | 74.78 | 74.91 | 74.85 | 8.63 | 4.02 | 21.59 |
| 7 | 74.39 | 74.45 | 74.42 | 8.66 | 4.14 | 21.20 |

1. A composition comprising:
iminodisuccinic acid (IDS) or its salt(s); and
sodium salt of polyaspartic acid (PASP);
wherein a ratio of iminodisuccinic acid (IDS) or its salt(s) to sodium salt of polyaspartic acid (PASP) is from 1:20 to 20:1 by weight, preferably from 1:10 to 10:1 by weight, and more preferably from 1:1 to 3:1 by weight; wherein the composition is a peroxide stabilizer suitable for bleaching pulp.

2. The composition according to claim 1, wherein the ratio of iminodisuccinic acid (IDS) or its salt(s) and sodium salt of polyaspartic acid (PASP) is 2:1 by weight.

3. The composition according to claim 1, wherein a molecular weight of sodium salt of polyaspartic acid is in a range of 2000-8000 Da, more preferably in the range of 3000-5000 Da.

4. The composition according to claim 1, wherein pH of the composition is in a range of 9-12, preferably pH is >10.

5. A method to bleach high yield pulp by adding a peroxide stabilizer, the peroxide stabilizer comprising the composition of claim 1.

6. The method of claim 5, wherein the high yield pulp comprises high yield mechanical pulp, high yield chemi-mechanical pulp, semi-chemical pulp or any combination of them.

7. A method for bleaching pulp, wherein a composition according to claim 1 is added to the pulp prior to bleaching during bleaching, or both prior to and during bleaching.

8. The method according to claim 7, wherein the composition is added to the pulp during a pre-treatment stage of the pulp.

9. The method according to claim 7, wherein the pulp comprises high yield mechanical pulp, high yield chemi-mechanical pulp, semi-chemical pulp or any combination of them.

10. The method according to claim 7, wherein the composition is added in an amount of 0.1-5 kg/t pulp (dry) or 0.5-5 kg/t pulp (dry).
